(19) United States
(12) Patent Application Publication
(10) Pub. No.: US 2020/0269779 A1
(43) Pub. Date: Aug. 27, 2020

(54) WIRE HARNESS

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Miyu ARAMAKI, Mie (JP); Hiroki HIRAI, Mie (JP); Housei MIZUNO, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 16/759,579

(22) PCT Filed: Aug. 20, 2018
(86) PCT No.: PCT/JP2018/030595

§ 371 Date: Apr. 27, 2020

(30) Foreign Application Priority Data
Nov. 9, 2017 (JP) 2017-216188

(51) Int. Cl. B60R 16/02

(52) U.S. Cl. CPC B60R 16/0215

(57) ABSTRACT

A wire harness includes a vehicle mounted component mounted to a vehicle and electrical wires, at least part of which extending along a longitudinal direction is bonded along the vehicle mounted component.

### TECHNICAL FIELD

The present invention relates to a technique of placing a wire harness in a vehicle.

### BACKGROUND ART

When a wire harness is attached to a vehicle, there is a ease where the wire harness is fixed to a vehicle body panel, and subsequently, an interior member is attached thereon as a technique described in Patent Document 1, for example.

Patent Document 1 discloses a technique of placing a wire harness in a side sill of a vehicle. The technique described in Patent Document 1 is to fix a protector housing an electrical wire to a vehicle body panel and cover a scuff plate on the protector.

### PRIOR ART DOCUMENTS

### Patent Documents

Patent Document 1: Japanese Patent Application Laid-Open No. 20099007

### SUMMARY

### Problem to be Solved by the Invention

However, there may be a possibility in the technique described in Patent Document 1 that a vibration occurs in the electrical wire so that measures against the vibration are necessary. Furthermore, there may also be a possibility that a working process in a vehicle assembly plant increases, or a placement space is narrowed and a weight increases in accordance with the placement of the protector.

Thus, an object of the present invention is to provide a technique more appropriate to place a wire harness in a vehicle.

### Means to Solve the Problem

In order to solve the above problem, a wire harness according to a first aspect includes a vehicle mounted component mounted to a vehicle and electrical wires, at least part of which extending along a longitudinal direction is bonded along the vehicle mounted component.

A wire harness according to a second aspect is the wire harness according to the first aspect, wherein the vehicle mounted component includes a rigid part formed of rigid plastic, and the electrical wires are bonded to the rigid part.

A wire harness according to a third aspect is the wire harness according to the second aspect, further including an anti-thermal stress structure part preventing damage to the electrical wires from a thermal stress caused by a difference in linear expansion coefficients between the electrical wires and the rigid part.

A wire harness according to a fourth aspect is the wire harness according to the third aspect, further including an elastic bonding layer intervening between the electrical wires and the rigid part and having elasticity, wherein the elastic bonding layer doubles as the anti-thermal stress structure part.

A wire harness according to a fifth aspect is the wire harness according to the third or fourth aspect, wherein formed as the anti-thermal stress structure part is a disconnection bonded part in which a plurality of bonded parts where the electrical wires and the rigid part are bonded are provided at intervals along a longitudinal direction of the electrical wires.

A wire harness according to a sixth aspect is the wire harness according to any one of the third to fifth aspects, wherein a meandering part in which the electrical wires meander in a bonding region where the electrical wires are bonded is formed as the anti-thermal stress structure part.

A wire harness according to a seventh aspect is the wire harness according to any one of the first to sixth aspects, wherein the electrical wires and the vehicle mounted component are bonded via a bonding layer.

A wire harness according to an eighth aspect is the wire harness according to the seventh aspect, wherein the bonding layer is provided on a surface of the vehicle mounted component.

A wire harness according to a ninth aspect is the wire harness according to the seventh or eighth aspect, wherein the bonding layer is provided on an outer periphery of each of the electrical wires.

A wire harness according to a tenth aspect is the wire harness according to any one of the seventh to ninth aspects, wherein the bonding layer contains thermoplastic resin.

A wire harness according to an eleventh aspect is the wire harness according to any one of the seventh to ninth aspects, wherein the bonding layer contains reaction curing resin.

A wire harness according to a twelfth aspect is the wire harness according to any one of the first to eleventh aspects, wherein the vehicle mounted component is an interior member having a design surface which is exposed, and the electrical wires are bonded to a surface on a back side of the design surface.

A method of assembling a wire harness according to a thirteenth aspect includes steps of: (a) bonding at least part of electrical wires extending along a longitudinal direction to a vehicle mounted component mounted to a vehicle to form a wire harness; and (b) assembling the wire harness to the vehicle after the step of (a).

### Effects of the Invention

According to the first to twelfth aspects, the electrical wires are bonded to the vehicle mounted component, thus a vibration of the electrical wires mounted to the vehicle can be suppressed. The electrical wires can be assembled at the same time when the vehicle mounted component is assembled to the vehicle.

Particularly, according to the second aspect, the rigid part and the electrical wires can be integrated with each other. At this time, the electrical wires can be protected with the rigid part.

When the electrical wires are bonded to a rigid member, there is a possibility that the electrical wires are damaged by the thermal stress. Even in this case, according to the third aspect, the anti-thermal stress structure part is provided, thus the electrical wires are hardly damaged even when the rigid part and the electrical wires are integrated with each other.

Particularly, according to the fourth aspect, the elastic bonding layer can absorb a difference in an expansion amount (a shrinkage amount) between the electrical wires and the rigid part.

Particularly, according to the fifth aspect, the disconnection bonded part is formed, thus the thermal stress is hardly concentrated in one position.

Particularly, according to the sixth aspect, the meandering part is formed, thus the thermal stress is hardly concentrated in one position.

According to the seventh aspect, the electrical wires and the vehicle mounted component which are hardly bonded directly can be easily bonded using the bonding layer.

Particularly, according to the eighth aspect, achievable is the bonding using the bonding layer which has been provided on the surface of the vehicle mounted component.

Particularly, according to the ninth aspect, achievable is the bonding using the bonding layer which has been provided on the outer periphery of each electrical wire.

Particularly, according to the tenth aspect, the bonding layer which has been provided previously can be melted by heating and simply bonded.

Particularly, according to the eleventh aspect, a heat resistance of the bonded part can be improved.

Particularly, according to the twelfth aspect, the electrical wires can be assembled to the vehicle together with the interior member.

According to the thirteen aspect, the electrical wires can be assembled to the vehicle together with the vehicle mounted component.

### BRIEF DESCRIPTION OF DRAWINGS

FIG. 1 A perspective view illustrating a wire harness according to a first embodiment.

FIG. 2 A side view illustrating the wire harness according to the first embodiment.

FIG. 3 A cross-sectional view of the wire harness cut along a III-III line in FIG. 1.

FIG. 4 A cross-sectional view illustrating a wire harness according to a second embodiment.

FIG. 5 A cross-sectional view illustrating a modification example of the wire harness according to the second embodiment.

FIG. 6 A side view illustrating a wire harness according to a third embodiment.

FIG. 7 A cross-sectional view illustrating a wire harness according to a fourth embodiment.

FIG. 8 A cross-sectional view illustrating the wire harness according to the fourth embodiment.

### DESCRIPTION OF EMBODIMENT(S)

### First Embodiment

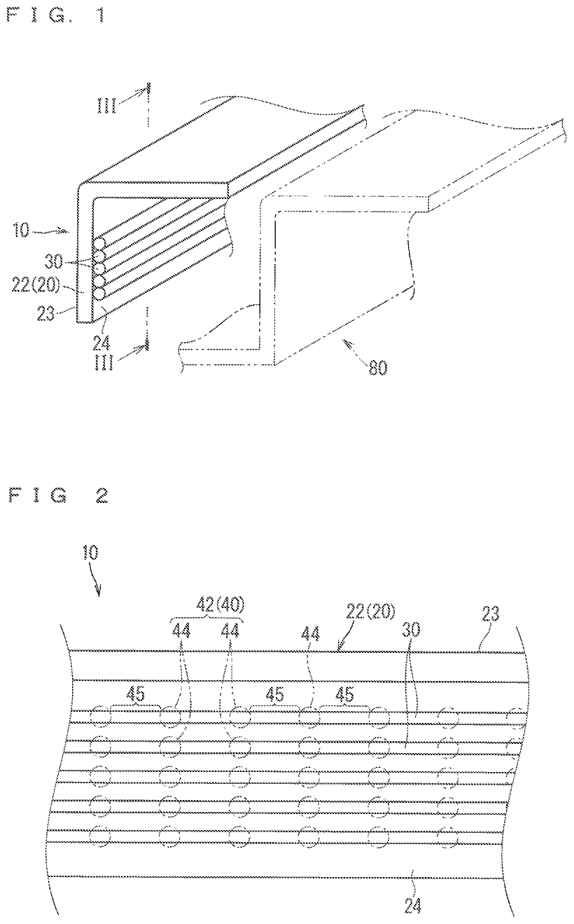

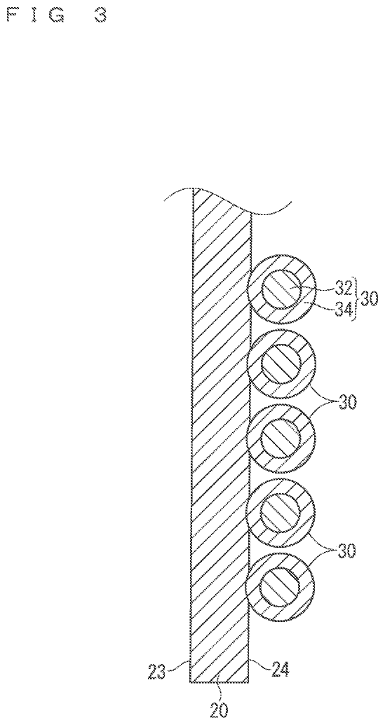

A wire harness according to a first embodiment is described hereinafter. FIG. 1 is a perspective view illustrating a wire harness 10 according to the first embodiment. FIG. 2 is a side view illustrating the wire harness 10 according to the first embodiment. FIG. 3 is a cross-sectional view of the wire harness cut along a III-III line in FIG. 1.

The wire harness 10 includes a vehicle mounted component 20 mounted to a vehicle and electrical wires 30, and at least part the electrical wires 30 extending along a longitudinal direction is bonded along the vehicle mounted component 20.

In the description, the vehicle mounted component 20 is an interior member having an exposed design surface. The interior member is considered a cover member covering a rocker part (a side sill) or a pillar, for example. The interior member is also considered an installment panel, for example. The interior member is also considered various types of trim such as a door trim, a roof trim, a trunk trim, for example. In the example illustrated in FIG. 1, the vehicle mounted component 20 is a cover member 22 covering a rocker part 80.

The cover member 22 is formed into an L shape in a cross section herein. In the cover member 22, an outer side surface 23 constitutes a design surface, and an inner side surface 24 faces a side of a vehicle body panel.

The vehicle mounted component 20 preferably has a rigid part formed of rigid plastic. In the example illustrated in FIG. 1, the cover member 22 is an integrally-molded member using single rigid plastic as a material. That is to say, the cover member 22 only has the rigid part. However, the vehicle mounted component 20 may have a non-rigid part formed of non-rigid plastic or cloth, for example. In this case, a placement surface of the vehicle mounted component 20 where the electrical wires 30 are disposed may be the rigid part. Accordingly, for example, it is considered that a design surface of the vehicle mounted component 20 is the non-rigid part and a back side of the design surface is a rigid part.

Each of the electrical wires 30 includes a core wire 32 and an insulating covering 34 for covering the core wire 32. The core wire 32 is formed of a conductor made of copper, copper alloy, aluminum, or aluminum alloy as a material, for example. The core wire 32 is normally a twisted wire made up of a plurality of twisted single wires, but may be a single core wire made up of a single wire. The insulating covering 34 is formed by extrusion molding, for example, a resin having insulation properties around the core wire 32. The insulating covering 34 is formed by applying a resin coating having insulation properties around the core wire 32, for example.

The electrical wires 30 have a configuration that at least part of the electrical wires 30 along the longitudinal direction is disposed and bonded to the placement surface of the vehicle mounted component 20. For example, a whole part of the electrical wires 30 extending along the longitudinal direction is considered to be disposed and bonded to the placement surface. For example, it is also considered that a middle portion of the electrical wires 30 extending along the longitudinal direction is disposed and bonded to the placement surface and an end portion thereof extends from the vehicle mounted component 20. Herein, the electrical wires 30 are bonded to a surface of the vehicle mounted component 20 on a back side of the design surface, more specifically, the inner side surface 24 described above of the cover member 22. Herein, the inner side surface 24 is the rigid part, and the electrical wires 30 are also considered to be bonded to the rigid part.

A hold structure part such as a groove for easily holding the electrical wires 30 is not formed in the placement surface where the electrical wires 30 are disposed in the vehicle mounted component 20. However, there may also be a case where the hold structure part such as a groove for easily holding the electrical wires 30 is formed in the placement surface.

A bonding form of bonding the electrical wires 30 to the vehicle mounted component 20 is not particularly limited, but various bonding forms can be adopted. For example, it is also considered that a resin located on a surface of at least one of each of the electrical wires 30 and the vehicle mounted component 20 is melted and directly bonded to the other component with no element therebetween. For example, it is also considered that the electrical wires 30 and the vehicle mounted component 20 are indirectly bonded to each other with a bonding layer therebetween. The case where the bonding layer intervenes is described in detail in a second embodiment hereinafter.

When the electrical wires 30 and the vehicle mounted component 20 are directly bonded to each other, a method of melting the resin on the surface is not particularly limited, however, a method capable of locally melting the resin may be preferably adopted. A method such as ultrasonic welding and laser welding, for example, can be adopted as the method capable of locally melting the resin.

When the electrical wires 30 and the vehicle mounted component 20 are directly bonded to each other, it is preferable that the insulating coverings 34 of the electrical wires 30 are not melted as much as possible but the surface of the vehicle mounted component 20 is mainly melted. For example, it is considered that in a state where the surface of the vehicle mounted component 20 is melted, the electrical wires 30 are disposed on the melted part of the surface. In this manner, it is considered that when the electrical wires 30 and the vehicle mounted component 20 are bonded in the state where the surface of the vehicle mounted component 20 is mainly melted, at least part of the electrical wires 30 is embedded into the vehicle mounted component 20 as illustrated in FIG. 3. At this time, a region to be embedded is not particularly limited. In the example illustrated in FIG. 3, a region smaller than a quarter of a periphery is embedded, however, also considered is that a region larger than the quarter of the periphery is embedded. Particularly, it is also considered that a region larger than a half of the periphery is embedded or a region of a whole periphery is embedded. As the region to be embedded gets larger, an adhesive force increases. In this case, the electrical wires 30 are embedded easily with decrease in a diameter of each electrical wire 30.

Herein, the wire harness 10 further includes an anti-thermal stress structure part 40.

Generally, a thermal expansion rate (a linear expansion coefficient) of rigid plastic used as a vehicle component is approximately several times to ten times larger than a thermal expansion rate of a metal conductor constituting the core wire 32 in many cases. Thus, a structure made up of a rigid plastic member and the electrical wires 30 firmly integrated with each other is exposed to a low temperature, a thermal stress in a shrinkage direction is applied to the electrical wires 30 by a shrinkage of the rigid plastic member, and in a worst case, there is a possibility that the core wire 32 is buckled in a position where the thermal stress is concentrated and finally disconnected.

The anti-thermal stress structure part 40 is a part preventing damage to the electrical wires 30 from the thermal stress caused by a difference in the linear expansion coefficients between the electrical wires 30 and the rigid part described above. Herein, a disconnection bonded part 42 is formed as the anti-thermal stress structure part 40.

The disconnection bonded part 42 is a part in which a plurality of bonded parts 44 where the electrical wires 30 and the rigid part are bonded are provided at intervals along the longitudinal direction of the electrical wires 30. That is to say, the disconnection bonded part 42 is also considered as a part where the bonded part 44 in which the electrical wires 30 and the rigid part are bonded and an unbonded part 45 in which the electrical wires 30 and the rigid part are not bonded are alternately provided along the longitudinal direction of the electrical wires 30. It is applicable that an interval between the bonded parts 44 where the electrical wires 30 and the rigid part are bonded is appropriately set, thus may be entirely provided at regular intervals or partially provided at different intervals. The disconnection bonded part 42 is provided, thereby being able to prevent the damage to the electrical wires 30 from the thermal stress. More specifically, in the unbonded part 45 in which the electrical wires 30 and the rigid part are not bonded in the disconnection bonded part 42, one of the electrical wires 30 and the rigid part does not suppress the other one thereof, and the unbonded part 45 is located adjacent to each bonded part 44, thus the electrical wires 30 in the unbonded part 45 bow and the thermal stress can be dispersed. Accordingly, the damage to the electrical wires 30 from the thermal stress can be prevented.

The electrical wires 30 and the vehicle mounted component 20 are attached to the wire harness 10 described above before being assembled to the vehicle. Accordingly, when the vehicle mounted component 20 in the wire harness 10 described above is assembled to the vehicle, the electrical wires 30 are also assembled to the vehicle. Thus, the assembly process of the electrical wires 30 can be simplified in the vehicle assembly plant.

According to the wire harness 10 having the configuration described above, the electrical wires 30 are bonded to the vehicle mounted component 20, thus the vibration of the electrical wires 30 mounted to the vehicle can be suppressed.

The rigid part and the electrical wires 30 can be integrated with each other. At this time, the electrical wires 30 can be protected with the rigid part.

When the electrical wires 30 are bonded to a rigid member, there is a possibility that the electrical wires 30 are damaged by the thermal stress. Even in this case, the anti-thermal stress structure part 40 is provided, thus a problem caused by the thermal stress hardly occurs even when the rigid part and the electrical wires 30 are integrated with each other. Particularly, the disconnection bonded part 42 is formed as the anti-thermal stress structure part 40, thus the thermal stress is hardly concentrated in one position,

The anti-thermal stress structure part 40 can also suppress the peeling of the bonded part 44 caused by the thermal stress.

The electrical wires 30 can be assembled to the vehicle together with the interior member 22 having the design surface 23.

### Second Embodiment

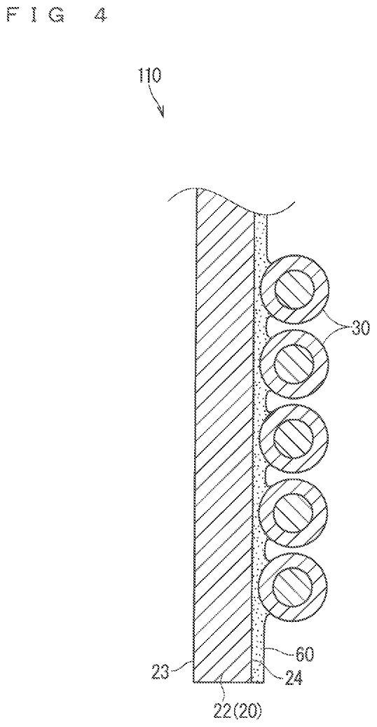

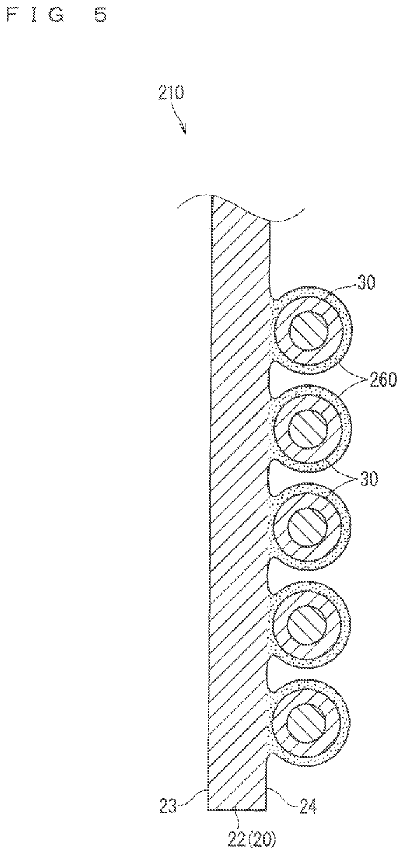

A wire harness according to a second embodiment is described. FIG. 4 is a cross-sectional view illustrating a wire harness 110 according to the second embodiment. FIG. 5 is a cross-sectional view illustrating a modification example of the wire harness 110 according to the second embodiment. In the description of the present embodiment, the same reference numerals are assigned to the similar constituent elements described above, and the description thereof will be omitted (the same applies to each embodiment described hereinafter).

The wire harness 110 according to the present embodiment indicates a case example that the electrical wires 30 and the vehicle mounted component 20 are bonded via a bonding layer 60.

The bonding layer 60 is formed of a material corresponding to a material constituting a surface of each of the electrical wires 30 and the vehicle mounted component 20 to be bonded. Herein, the bonding layer 60 is provided on the placement surface 24 of the vehicle mounted component 20. At this time, the bonding layer 60 is also provided on part of the placement surface 24 of the vehicle mounted component 20 where the electrical wires 30 are not disposed. In the example illustrated in FIG. 4, the bonding layer 60 is uniformly provided on part of the placement surface of the vehicle mounted component 20 where the electrical wires 30 are disposed and around the part thereof.

However, as illustrated in FIG. 5, the bonding layer may be provided on a side of the electrical wires 22. In a wire harness 210 illustrated in FIG. 5, a bonding layer 260 is provided on an outer periphery of each electrical wire 30. At this time, in the example illustrated in FIG. 5, the bonding layer 260 is provided around a whole periphery of the outer periphery of each electrical wire 30. However, even when the bonding layer 260 is provided on the outer periphery of each electrical wire 30, there may be a case where the bonding layer 260 is provided on only part of the electrical wires 30 along a circumferential direction. The bonding layer 260 is provided with a uniform thickness, but may have part with a different thickness along the circumferential direction.

It is considered that a state of the bonding layers 60 and 260 can be reversibly changed to an attachable state and an unattachable state. The bonding layers 60 and 260 are considered to contain thermoplastic resin, for example. The thermoplastic resin is considered, for example, nylon, polypropylene, polyvinyl chloride, ethylene-vinyl acetate copolymer resin. The thermoplastic resin may be made up of one type of resin or a mixture of a plural types of resin. At this time, a melting point of the thermoplastic resin contained in the bonding layers 60 and 260 is preferably lower than a melting point of resin constituting the electrical wires 30 and resin constituting the vehicle mounted component 20.

The bonding layer 60 is considered to be formed of a material of the same system as a material constituting the placement surface 24 of the vehicle mounted component 20 and a material containing a large amount of plasticizing agent. Accordingly, the electrical wires 30 can be easily embedded into the bonding layer 60.

When the state of the bonding layers 60 and 260 can be reversibly changed to the attachable state and the unattachable state, the bonding layers 60 and 260 are previously provided on at least one of the electrical wires 30 and the vehicle mounted component 20, and are in the unattachable state. Then, in the bonding process, the state of the bonding layers 60 and 260 previously provided on at least one of the electrical wires 30 and the vehicle mounted component 20 are changed from the unattachable state to the attachable state. When the electrical wires 30 and the vehicle mounted component 20 are bonded via the bonding layers 60 and 260 in this state, the state of the bonding layers 60 and 260 is changed from the attachable state to the unattachable state again.

More specifically, the material containing the melted thermoplastic resin is provided on the electrical wires 30 or the vehicle mounted component 20, and then cooled and solidified, thus achievable is the configuration that the bonding layers 60 and 260 are previously provided and then enter the unattachable state. For example, when the bonding layers 60 and 260 are provided on the vehicle mounted component 20, the material containing the melted thermoplastic resin is considered to be applied to the placement surface 24 of the vehicle mounted component 20. Also considered is that the vehicle mounted component 20 is provided by two-color molding when the vehicle mounted component 20 is molded using a mold. For example, when the bonding layers 60 and 260 are provided on the electrical wires 30, the material containing the melted thermoplastic resin is considered to be applied to the outer peripheral surface of the electrical wires 30. Also considered is that the material containing the melted thermoplastic resin is extrusion-molded around the electrical wires 30.

Next, the bonding layers 60 and 260 are heated by a heating method such as sending hot air so that the bonding layers 60 and 260 enter the attachable state, and then the electrical wires 30 are disposed on the vehicle mounted component 20 to bond the electrical wires 30 and the vehicle mounted component 20 via the bonding layers 60 and 260. Subsequently, the bonding layers 60 and 260 are cooled and solidified, thereby being able to enter the unattachable state again.

It is also applicable that the bonding layers 60 and 260 are heated after the electrical wires 30 are disposed to change the state of the bonding layers 60 and 260 to the attachable state using a method such as the ultrasonic welding and the laser welding.

According to the wire harnesses 110 and 210 described above, the electrical wires 30 and the vehicle mounted component 20 which are hardly bonded directly can be easily bonded using the bonding layers 60 and 260.

When the bonding layers 60 and 260 contain the thermoplastic resin, the bonding layers 60 and 260 which have been provided previously can be melted by heating and simply bonded.

At this time, according to the wire harness 110, achievable is the bonding using the bonding layer 60 which has been provided on the surface of the vehicle mounted component 20.

According to the wire harness 210, achievable is the bonding using the bonding layer 260 which has been provided on the outer periphery of each electrical wire 30.

### Third Embodiment

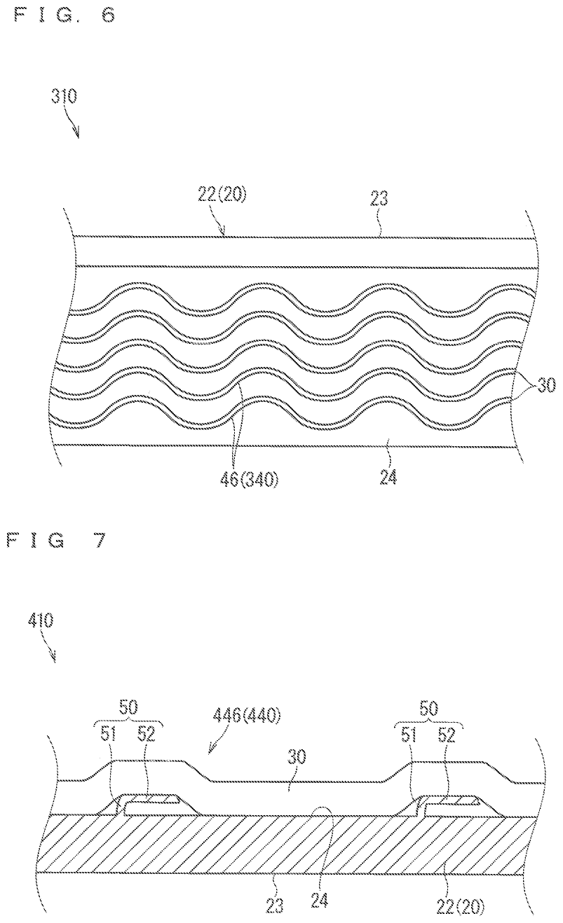

A wire harness according to a third embodiment is described. FIG. 6 is a side view illustrating a wire harness 310 according to the third embodiment.

In the wire harness 310 according to the present embodiment, a structure of an anti-thermal stress structure part 340 is different from that of the anti-thermal stress structure part 40 in the wire harness 10 according to the first embodiment. Particularly, a meandering part 46 in which the electrical wires 30 meander in the bonding region where the electrical wires 30 are bonded is formed as the anti-thermal stress structure part 340. In this case, the electrical wires 30 and the vehicle mounted component 20 are serially bonded over the whole meandering part 46. However, the electrical wires 30 and the vehicle mounted component 20 may be intermittently bonded over the whole meandering part 46. Considered in this case is a configuration that the electrical wires 30 and the vehicle mounted component 20 are bonded in a vertex of a curved part and the electrical wires 30 and the vehicle mounted component 20 are not bonded in a midway part between the vertexes, for example.

Herein, the electrical wires 30 meander uniformly along the longitudinal direction in the meandering part 46. The electrical wires 30 meander in a direction parallel to a direction in which the placement surface 24 extends. However, the meandering form is not particularly limited. There may be a case where there are part of the electrical wires 30 having a large meandering along the longitudinal direction and part of the electrical wires 30 having a small meandering. There, may also be a case where the electrical wires 30 meander on the placement surface 24 in a normal line direction. This case is described in detail in a fourth embodiment hereinafter.

The meandering part 46 includes a plurality of curved parts. Thus, even when the thermal stress occurs, the thermal stress is dispersedly applied to each of the plurality of curved parts. Accordingly, according to the wire harness 310, the meandering part 46 is formed, thus the thermal stress is hardly concentrated in one position. The meandering part 46 is provided, thus a difference in degree of expansion and shrinkage between the electrical wires 30 and the rigid part in accordance with a difference in the linear expansion coefficients can be absorbed.

### Fourth Embodiment

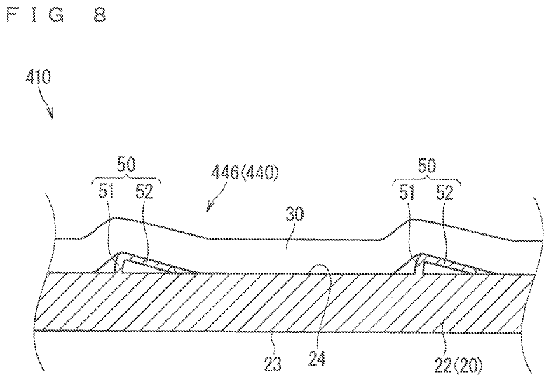

A wire harness according to a fourth embodiment is described. FIG. 7 and FIG. 8 are vertical cross-sectional views each illustrating a wire harness 410 according to the fourth embodiment.

In the wire harness 410 according to the present embodiment, a meandering part 446 in which the electrical wires 30 meander in the bonding region where the electrical wires 30 are bonded is formed as an anti-thermal stress structure part 440. Described herein is a case example that the electrical wires 30 meander on the placement surface 24 in the normal line direction in the meandering part 446. Described herein is a case example that an elastic support part 50 supporting the meandering part 46 is provided.

The elastic support part 56 is provided on the vehicle mounted component 20. In the example illustrated in FIG. 7, the elastic support part 50 is formed into a spring shape (a plate spring shape). Specifically, the elastic support part 50 is formed into a shape including a support column part 51 protruding on the placement surface 24 to extend in a direction away from the placement surface 24 and a cantilever arm part 52 protruding on a tip portion side of the support column part 51.

At this time, the electrical wires 30 are disposed on the elastic support part 50 (on the cantilever arm part 52 herein). When the thermal stress is applied to the electrical wires 30, the elastic support part 50 bows as illustrated in FIG. 8, thus the thermal stress can be absorbed. The electrical wires 30 and the elastic support part 50 may be bonded to each other or may not be bonded.

According to the wire harness 410, the meandering part 446 is formed, thus the thermal stress is hardly concentrated in one position. The elastic support part 50 is formed, thereby being able to support the meandering part 446.

Also considered is that the elastic support part 50 is formed of an elastic material such as rubber or foaming resin, for example. In this case, the elastic support part 50 is considered to be formed into small pieces and attached to the vehicle mounted component 20 or the electrical wires 30.

### MODIFICATION EXAMPLE

Described above are the case examples that the anti-thermal stress structure part is the disconnection bonded part 42 and the meandering part 46, however, also considered is that the anti-thermal stress structure part has the other configuration. For example, considered is a case where the bonding layer 60 described above is an elastic bonding layer 60, and the elastic bonding layer 60 doubles as the anti-thermal stress structure part. The elastic bonding layer 60 as the bonding layer 60 is provided, thereby being able to absorb a difference in an expansion amount (a shrinkage amount) between the electrical wires 30 and the rigid part. It is considered that the elastic bonding layer 60 is formed using a so-called elastic bonding agent mainly containing synthetic rubber, epoxy resin, or silicon resin, for example. It is also considered that a material containing a foaming agent as one component of the bonding agent mainly containing the resin is used, and the resin which is the main component is foamed to be the foam resin, thereby having elasticity.

In the above description, the state of the bonding layer 60 can be reversibly changed to the attachable state and the unattachable state, however, this configuration is not necessary. It is also considered that the state of the bonding layer 60 cannot be changed to the attachable state once the state is changed from the attachable state to the unattachable state. Such a bonding layer 60 contains reaction curing resin, for example. Considered as the reaction curing resin are ultraviolet curing resin, thermal curing resin, moisture curing resin, and two-liquid reaction curing resin. The bonding layer 60 contains the reaction curing resin, thus a heat resistance of the bonded part 44 can be improved.

In the above description, the bonding layer 60 is made up of a material other than an adhesive agent, but is also considered to be formed of the adhesive agent. The bonding layer 60 is formed by attaching a double-sided adhesive tape, for example.

The electrical wires 30 are also considered to be bonded to a non-rigid part of the vehicle mounted component 20. In this case, there may also be a case where the vehicle mounted component 20 does not have the rigid part.

In the above description, the wire harness includes the anti-thermal stress structure part, however, this configuration is not necessary. There may also be a case where the anti-thermal stress structure part is omitted.

The configurations described in the embodiments and modification examples thereof can be appropriately combined as long as they are not contradictory.

Although the present invention is described in detail, the foregoing description is in all aspects illustrative and does not restrict the invention. It is therefore understood that numerous modifications and variations can be devised without departing from the scope of the invention.

### EXPLANATION OF REFERENCE SIGNS

10 wire harness
20 vehicle mounted component
22 cover member (interior member)
23 outer side surface (design surface)
24 inner side surface
30 electrical wire
32 core wire
34 insulating covering
40 anti-thermal stress structure part
42 disconnection bonded part
44 bonded part
46 meandering part
50 elastic support part
51 support column part
52 cantilever arm part
60 the bonding layer

1. (canceled)

2. A wire harness, comprising:
a vehicle mounted component mounted to a vehicle; and
a plurality of electrical wires, at least part of which extending along a longitudinal direction is bonded along the vehicle mounted component, wherein
the vehicle mounted component includes a rigid part formed of rigid plastic, and
each of the plurality of the electrical wires is separately bonded to the rigid part in a state where insulating coverings of the electrical wires are directly bonded to the rigid part.

3. The wire harness according to claim 2, further comprising
an anti-thermal stress structure part preventing damage to the electrical wires from a thermal stress caused by a difference in linear expansion coefficients between the electrical wires and the rigid part.

4. The wire harness according to claim 3, further comprising
an elastic bonding layer intervening between the electrical wires and the rigid part and having elasticity, wherein
the elastic bonding layer doubles as the anti-thermal stress structure part.

5. The wire harness according to claim 3, wherein
formed as the anti-thermal stress structure part is a disconnection bonded part in which a plurality of bonded parts where the electrical wires and the rigid part are bonded are provided at intervals along a longitudinal direction of the electrical wires.

6. The wire harness according to claim 3, wherein
a meandering part in which the electrical wires meander in a bonding region where the electrical wires are bonded is formed as the anti-thermal stress structure part.

7-11. (canceled)

12. The wire harness according to claim 2, wherein
the vehicle mounted component is an interior member having a design surface which is exposed, and
the electrical wires are bonded to a surface on a back side of the design surface.

13. (canceled)
